(19) United States
(12) Patent Application Publication
(10) Pub. No.: US 2026/0169806 A1
(43) Pub. Date: Jun. 18, 2026

(54) EVENTS-AWARE AUTOSCALING

(71) Applicant: INTERNATIONAL BUSINESS MACHINES CORPORATION, ARMONK, NY (US)

(72) Inventors: Dinesh C. Verma, New Castle, NY (US); Alessandro Donatelli, Roma (IT); Luis Angel Bathen, San Jose, CA (US); Sean Lee Stuckless, London (CA); Qingyan Wang, Sudbury, MA (US)

(21) Appl. No.: 18/985,852

(22) Filed: Dec. 18, 2024

(51) Int. Cl. G06F 9/50; G06N 20/00

(52) U.S. Cl. CPC G06F 9/5027; G06N 20/00

(57) ABSTRACT

In a method for events-aware autoscaling, a sequence of events of an executing application is identified, where the executing application is allocated resources and the identifying occurs via automated analysis of data from the executing application. The sequence of events is input into a trained Artificial Intelligence (AI) model. A resource allocation recommendation that identifies one or more resources and corresponding amounts of the one or more resources to allocate is received from the trained AI model in response to the inputting. The allocated resources are adjusted based on the resource allocation recommendation.

### BACKGROUND

Embodiments of the invention relate to artificial intelligence for information technology (IT) operations (AIOps) and to autoscaling techniques that are part of AIOps.

### SUMMARY

In accordance with certain embodiments, a computer-implemented method comprising operations is provided for events-aware autoscaling. In such embodiments, a sequence of events of an executing application is identified, where the executing application is allocated resources and the identifying occurs via automated analysis of data from the executing application. The sequence of events is input into a trained Artificial Intelligence (AI) model. A resource allocation recommendation that identifies one or more resources and corresponding amounts of the one or more resources to allocate is received from the trained AI model in response to the inputting. The allocated resources are adjusted based on the resource allocation recommendation.

In accordance with other embodiments, a computer program product comprising a computer readable storage medium having program code embodied therewith is provided, where the program code is executable by at least one computer processor to perform operations for events-aware autoscaling. In such embodiments, a sequence of events of an executing application is identified, where the executing application is allocated resources and the identifying occurs via automated analysis of data from the executing application. The sequence of events is input into a trained Artificial Intelligence (AI) model. A resource allocation recommendation that identifies one or more resources and corresponding amounts of the one or more resources to allocate is received from the trained AI model in response to the inputting. The allocated resources are adjusted based on the resource allocation recommendation.

In accordance with yet other embodiments, a computer system comprises one or more computer processors, one or more computer-readable memories and one or more computer-readable, tangible storage devices; and program instructions, stored on at least one of the one or more computer-readable, tangible storage devices for execution by at least one of the one or more computer processors via at least one of the one or more memories, to perform operations for events-aware autoscaling. In such embodiments, a sequence of events of an executing application is identified, where the executing application is allocated resources and the identifying occurs via automated analysis of data from the executing application. The sequence of events is input into a trained Artificial Intelligence (AI) model. A resource allocation recommendation that identifies one or more resources and corresponding amounts of the one or more resources to allocate is received from the trained AI model in response to the inputting. The allocated resources are adjusted based on the resource allocation recommendation.

### BRIEF DESCRIPTION OF THE DRAWINGS

Referring now to the drawings in which like reference numbers represent corresponding parts throughout:

FIG. 1 illustrates a computing environment in accordance with certain embodiments.

FIG. 2 illustrates a computing environment for an events-aware autoscaling resource manager in accordance with certain embodiments.

FIG. 3 illustrates a graph of resource usage in accordance with certain embodiments.

FIG. 4 illustrates another graph of resource usage in accordance with certain embodiments.

FIG. 5 illustrates a test environment for training a base Artificial Intelligence (AI) model in accordance with certain embodiments.

FIG. 6 illustrates a deployment environment for generating a new (fine-tuned) trained AI model in accordance with certain embodiments.

FIG. 7 illustrates a table comparing performance for an event-aware trained AI model and an event-agnostic trained model in accordance with certain embodiments.

FIG. 8 illustrates a graph of actual resource consumption versus a prediction of resources using an event-aware Decision Tree Regression model in accordance with certain embodiments.

FIG. 9 illustrates a graph of actual resource consumption versus a prediction of resources using an event-agnostic Resource Extrapolation model in accordance with certain embodiments.

FIG. 10 illustrates, in a flowchart, operations for training and using a trained AI model in accordance with certain embodiments.

FIG. 11 illustrates, in a flowchart, operations for events-aware autoscaling in accordance with certain embodiments.

FIG. 12 illustrates, in a block diagram, details of a machine learning model in accordance with certain embodiments.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

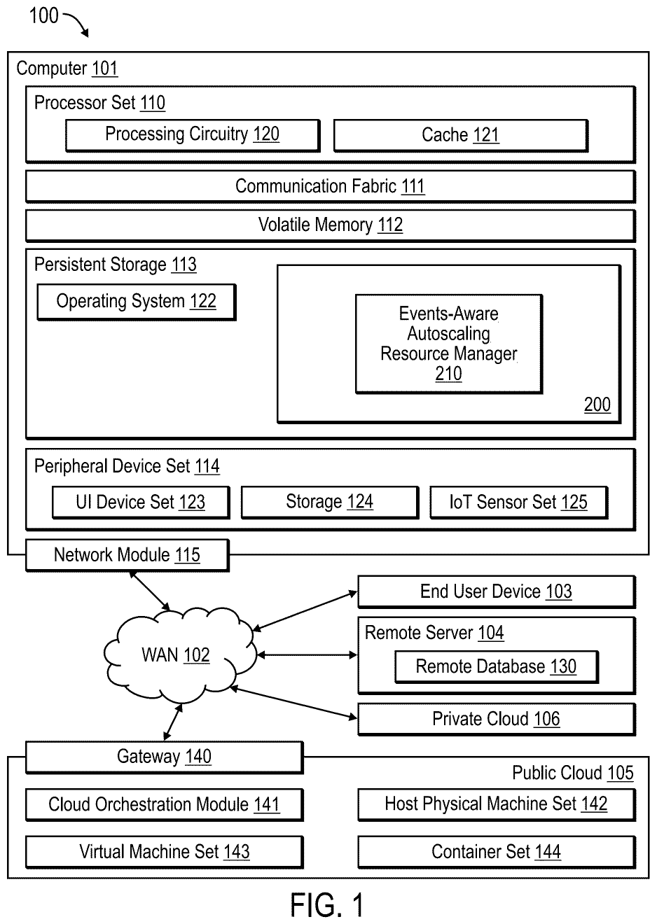

Computing environment 100 of FIG. 1 contains an example of an environment for the execution of at least some of the computer code involved in performing the inventive methods, such as code for an events-aware autoscaling resource manager 210 of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set 110 may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the

various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

Autoscaling may be described as dynamically allocating resources to match desired performance. Autoscaling of applications (i.e., software) is performed in many systems in order to maximize resource consumption, while maintaining the performance of the systems.

In hosted environments, a pod includes one or more containers, and each container includes an application. In such environments, an external resource manager may allocate additional pods of an application and modify the resources required by a container.

In addition, conventional application scaling solutions deal with an application instance as a single unit to perform auto-scaling and measurements. This may cause a performance issue with some applications (e.g., an asset manager).

The asset manager may need more memory when a new asset class is loaded into the system. However, the longer term memory and Central Processing Unit (CPU) utilization when the asset update requests are made may be lower. Conventional application scaling solutions may allocate too little memory to the system for the asset manager, which degrades the performance of the asset manager when used with existing autoscaling managers. That is, when a new asset class needs to be loaded, the asset manager performs very slowly because it does not have adequate resources.

Conventional application scaling solutions do not recognize different modalities of applications and do not have a good handle on the overall performance of the applications. Some of these conventional application scaling solutions are vertically scaling systems.

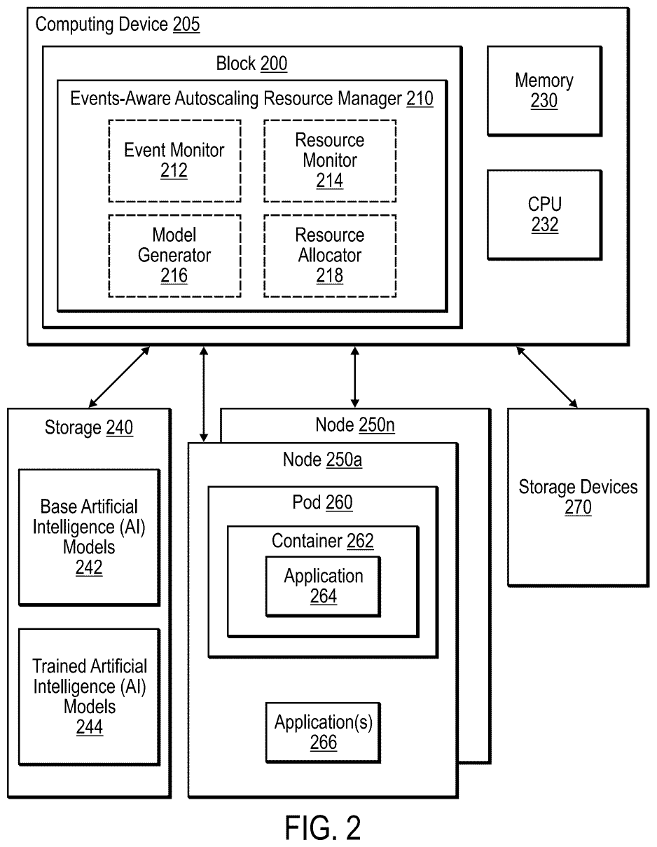

Some conventional application scaling solutions are reactive to events to drive scaling of systems (e.g., horizontally scaling systems that create new instances). FIG. 2 illustrates a computing environment for an events-aware autoscaling resource manager 210 in accordance with certain embodiments. The events-aware autoscaling resource manager 210 may be referred to as a resource manager.

In FIG. 2, the computing device 205 includes block 200, which includes the events-aware autoscaling resource manager 210, memory 230, and Central Processing Unit (CPU) 232. The computing device 205 is connected to storage 240, nodes 250a. . . 250n, and storage devices 270. The computing device 205 may have the components of computer 101.

The storage 240 includes one or more base Artificial Intelligence (AI) models 242 (i.e., base machine learning models) and one or more corresponding trained AI models 244 (i.e., trained machine learning models). In certain embodiments, the base AI model 242 learns the characteristics of a given application (i.e., is trained) to generate the corresponding trained AI model 244 for the given application. Thus, there may be different trained AI models 244 for different applications. The model generator 216 generates the trained AI models 244 from the base AI models 242.

Each node 250a. . . 250n includes equivalent components to those of node 250a. The node 250a includes a pod 260 with at least one container 262. The container 262 includes an application 264. The node 250a may also include applications 266 that are not in containers. Each node may be a virtual machine on a computer or may be a computer having the components of computer 101, including a memory and a CPU.

In certain embodiments, the events-aware autoscaling resource manager 210 includes sub-components of: an event monitor 212 (to monitor events of an application 264, 266), a resource monitor 214 (to monitor resource usage by the application 264, 266), a model generator 216 (to generate the trained AI models 244 based on the events from the event monitor 212 and the resource usage from the resource monitor 214), and a resource allocator 218 (to allocate resources based on the resource allocation recommendation from the trained AI model 244 for the application 264, 266).

In certain embodiments, events are facts monitored by the event monitor 212. The monitored facts are of interest to the base AI model 242 for training. For example, events encompass external messages, calls, requests, starting of jobs, modifications of configuration, actions, occurrences, changes of state, etc.

The events-aware autoscaling resource manager 210 controls access to a certain amount and kind of resources (e.g., memory 230, CPU 232, network bandwidth, storage devices 270, etc.), and the events-aware autoscaling resource manager 210 dynamically allocates the resources to the applications 264, 266.

The events-aware autoscaling resource manager 210 allocates resources more intelligently, and so does not degrade the performance of the applications 264, 266 (e.g., such as an asset management system). In certain embodiments, the events-aware autoscaling resource manager 210 is applicable to vertical scaling systems and is able to account for the resources used by a system in different modalities. This includes systems that leverage deep profiling of their environment's full stack to drive resource allocation and scheduling.

Unlike conventional autoscaling managers that fail to make intelligent choices because they make decisions on the overall performance of an application and are unaware of the context under which the application is operating, the events-aware autoscaling resource manager 210 determines the context of operation in many applications by identifying events that appear within the system. In certain embodiments, “system” may be described as a cluster, which is a set of nodes 250a. . . 250n on which the pods run. By linking the awareness of events to the system, the events-aware autoscaling resource manager 210 performs a more efficient task of managing the resources of an application without impacting its performance.

An application may be packaged (included in) a container, and the container may be included in a pod. In a deployment, multiple containers may be executing along with the events-aware autoscaling resource manager 210. In certain embodiments, the events-aware autoscaling resource manager 210 observes the longer-term usage of system resources (e.g., memory 230, CPU 232, network bandwidth consumption, storage devices 270, etc.) along with events. The events-aware autoscaling resource manager 210 may adjust the system resources (e.g., reduce or increase the maximum memory, the processor share, the network bandwidth, etc.) allocated to the container.

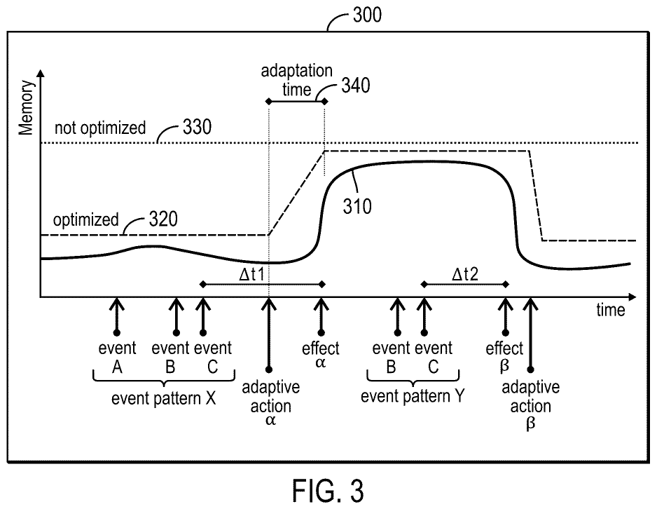

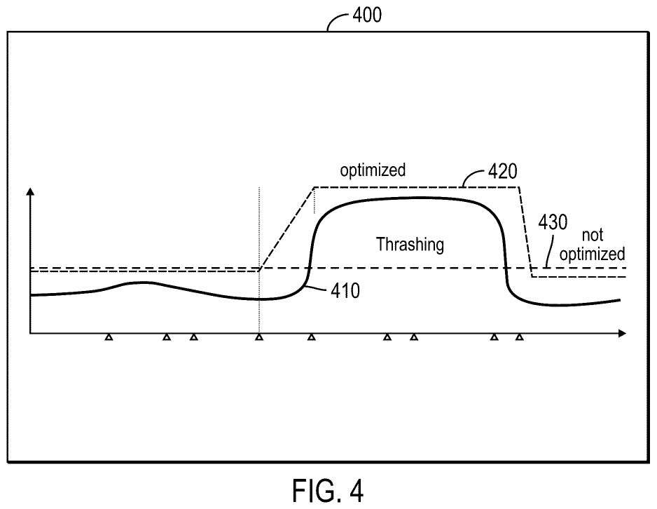

Some applications may have multiple modalities of operations. For example, an asset manager uses more processor and memory resources when new asset classes are loaded into the system, while using less processor and memory resources when asset information is updated. The events-aware autoscaling resource manager 210 looking at system performance, along with the events, allocates resources based on the modality instead of peak memory usage that generates waste (e.g., as shown in FIG. 3) or average usage that may generate thrashing (e.g., as shown in FIG. 4).

In order to not degrade the performance of the system, the events-aware autoscaling resource manager 210 understands that the application may operate in more than one modality. The events-aware autoscaling resource manager 210 adjusts resource allocation to the system when the application operates in a different modality. Unlike conventional systems that do not have the awareness of these modalities, the events-aware autoscaling resource manager 210 determines different modalities by observing the events and the short and long term consequences to the system and application performance.

The events-aware autoscaling resource manager 210 recognizes that the application goes into different modalities depending on the type of request that is coming to the application. In certain embodiments, “modalities” are observed operating patterns in which a resource adjustment was implemented, where the operating pattern has been learned by the base AI model 242 via training. This request may come from an event on an enterprise service bus or as a request from a client over an interface, such as a web-service Application Programming Interface (API) call. Because the events-aware autoscaling resource manager 210 is aware of the events that introduce the application into different modalities, the events-aware autoscaling resource manager 210 is able to assign appropriate resources to the application at the right time.

Embodiments introduce the events-aware autoscaling resource manager 210 (i.e., an intelligent scaling manager) that not only looks at the longer term resource usage of the application, but also observes the events made to the application. The events-aware autoscaling resource manager 210 uses a trained AI model 244 that has been trained to receive information indicating a sequence of events (i.e., “facts”) and, in response, provide a resource allocation recommendation (i.e., a storage action) appropriate for that particular sequence of events. Thus, on the arrival of information that represents a first sequence of events, the events-aware autoscaling resource manager 210 is able to automatically and dynamically allocate more resources to the application. On the arrival of information that is representative of a second sequence of events, the events-aware autoscaling resource manager 210 is able to automatically and dynamically allocate fewer resources to the application. Thus, the events-aware autoscaling resource manager 210 provides resource allocations that do not impact the performance of the applications as they switch modalities.

In certain embodiments, the base AI model 242 is trained on the following facts:
<event sequence> <adaptive action> <adaptation time>

The adaptation time may be described as the timeframe or a period of time after which the performance may degrade if the adaptive action is not taken. To avoid performance degradation, during the adaptation time, the adaptive action is taken (e.g., a resource is increased or decreased). For example, if event sequence “abc” occurs, the adaptive action is to increase memory by 10 Gigabytes, and the adaptation time is 5 seconds. The graph 300 of FIG. 3 illustrates that, during the adaptation time 340, memory is increased.

In certain embodiments, the application exports information representing the sequences of events for which the application requires additional resources or fewer resources.

The model generator 216 of the events-aware autoscaling resource manager 210 automates the creation of the trained AI models 244 to be used for the modality determination and related adaptive actions. The model generator 216 may also be referred to as a model learner. In certain embodiments, the model generator 216 facilitates and/or orchestrates training of a base AI model 242 to recognize notable event sequences that happen for an application that is running. Training data is generated by labelling certain sets of metrics and/or logs with a name of a particular event and/or event sequence that are indicated in the particular metrics and/or logs as occurring. This trained machine learning model is then used as part of the event monitor 212 to receive metrics and/or logs as input and from that input information identify events and/or sequences of events that are or have recently occurred for the running applications. For example, a word message that includes a name of an identified event or identified event sequence is output from the trained machine learning model of the event monitor 212 and used as input for a trained machine learning model for the resource allocator 218.

In certain embodiments, the model generator 216 facilitates and/or orchestrates training of a base AI model 242 on observations (e.g., events) of the resource consumption of the application in a test setting and/or a deployment setting. For example, the model generator 216 facilitates and/or orchestrates training of a base AI model 242 on the amount of resources that are used for each type of event on the system and automatically determines the event sequence that requires more or fewer resources. The model generator 216 stores the trained AI model 244 for use by the events-aware autoscaling resource manager 210. That is, the model generator 216 passes (or exports) the trained AI model 244 to the events-aware autoscaling resource manager 210.

In certain embodiments, the model generator 216 trains the base AI model 242 based on a detected pattern of resource usage by an application in a test setting and/or a deployment setting to generate a trained AI model 244. Once the trained AI model 244 is generated, the events-aware autoscaling resource manager 210 uses the trained AI model 244 to predict future resource usage of the application in the deployment setting.

In alternative embodiments, the model generator 216 learns the correlation between the resources and an event sequence based on information/data representing the resource consumption of the application and the event sequences that are arriving at the system. By learning the correlation between information/data representing the types and/or the pattern of events that arrive and information/data representing the resource utilization for some time interval (i.e., a monitored time interval) after the arrival of the information/data that represents the event sequence, the model generator 216 trains the base AI model 242 to learn which types and/or patterns of events are associated with different types of resource utilization. Based on this, the model generator 216 is able to generate the trained AI model 244.

Using the knowledge of resource consumption of the application on a variety of events, the events-aware autoscaling resource manager 210 identifies an adaptive action to be put in place to optimize the resource utilization. The events-aware autoscaling resource manager 210 also considers the time to adapt to the situation (i.e., the amount of time to increase or decrease resources based on predicting future resource usage using the trained AI model 244).

FIG. 3 illustrates a graph 300 of resource usage in accordance with certain embodiments. In the graph 300, line 310 represents resources that are consumed/needed by the application, line 320 represents resources allocated by the events-aware autoscaling resource manager 210, and line 330 represents resources allocated by a conventional system. Line 330 indicates that the conventional system allocates too much memory based on long term resource usage. Line 320 indicates that the events-aware autoscaling resource manager 210 allocates resources dynamically so that the application has an optimal amount of resources at any given time.

In addition, the events-aware autoscaling resource manager 210 knows that to implement an adaptive action α to prepare for an effect α after having observed an event pattern X, there is a lag time of Δt1 between (A) a start of a modality as indicated by a significant number of events in an event sequence and (B) the adaptive action α. There is also a second lag referred to as the adaptive action α adaptation time represented by line 340 that is between (A) the start of the adaptive action α and (B) the when the effect of the event sequence starts.

As can be seen from the graph 300, the events-aware autoscaling resource manager 210 recognizes that the application switches modes and uses different amounts of resources. For example, the events-aware autoscaling resource manager 210 identifies a specific type of message on Enterprise Service Bus (ESB) oriented applications or a specific type of request of REpresentational State Transfer (REST) oriented applications and determines that the application is about to switch modalities. Then, the events-aware autoscaling resource manager 210 allocates resources to the application accordingly. For example, events in the event pattern Y are recognized by the events monitor 212 as a particular sequence. This recognition causes the events monitor 212 to send a message which triggers a message to the trained AI model 244, which receives the message representing the events sequence and, in response, provides a prediction that application consumption of the resource will soon decrease (starting at effect β and occurring in full or substantially in full by adaptive action β point) so that less resources need to be allocated for the applications at that time. The changed optimized line 320 shows that the system allocates less resources while still providing enough through the decrease period and ultimately resource savings are achieved by the dynamic allocation of resources via the events-aware autoscaling resource manager 210.

FIG. 4 illustrates another graph 400 of resource usage in accordance with certain embodiments. In graph 400, line 410 represents resources being consumed/needed by the application that is executing, line 420 represents resources allocated by the events-aware autoscaling resource manager 210, and line 430 represents resources allocated by a conventional system. Line 430 indicates that the conventional system allocates too little memory to account for the period of increased resources needed by the applications over a particular time period. Line 420 indicates that the events-aware autoscaling resource manager 210 allocates resources dynamically so that the application has an optimal amount of resources at any given time.

For example, with reference to the graph 400, when an asset manager is running in an environment with shared resources, if the application does not have enough resources when a new asset creation request comes up, the application thrashes.

The events-aware autoscaling resource manager 210 monitors events coming into the system and trains a base AI model 242 to generate a trained AI model 244. The trained AI model 244 takes input event sequences for an application and predicts (i.e., generates an output of) a resource allocation recommendation at a given point in time.

The following are trained AI model 244 inputs and outputs for an application during deployment:
Trained AI Model Inputs: <event sequence>, <application>
Trained AI Model Output: <resource allocation recommendation>

In certain embodiments, with an event sequence for a particular application (e.g., identified by an application identifier), the trained AI model 244 outputs the resource allocation recommendation. Based on the resource allocation recommendation, the events-aware autoscaling resource manager 210 allocates resources to the application on a fine granularity to meet the resource requirements of the application.

In certain embodiments, the amount of allocation of resources is based on the application and the last few events (i.e., an event sequence). In certain embodiments, the events-aware autoscaling resource manager 210 identifies the events of the event sequences by parsing log events from a log associated with the application or with the application container. In some embodiments, the parsed log events are input into a rules-based events monitor or a trained machine learning model that is part of the events monitor 212.

In certain embodiments, the base AI model 242 may be trained in one of two ways: 1) run the application using a test harness and learn the events and resource usage to train the base AI model 242, and 2) run the application during operation (deployment) and learn the events and resource usage to train the base AI model 242. A test harness may be described as a collection of software and test data used to unit test the base AI model 242 during development.

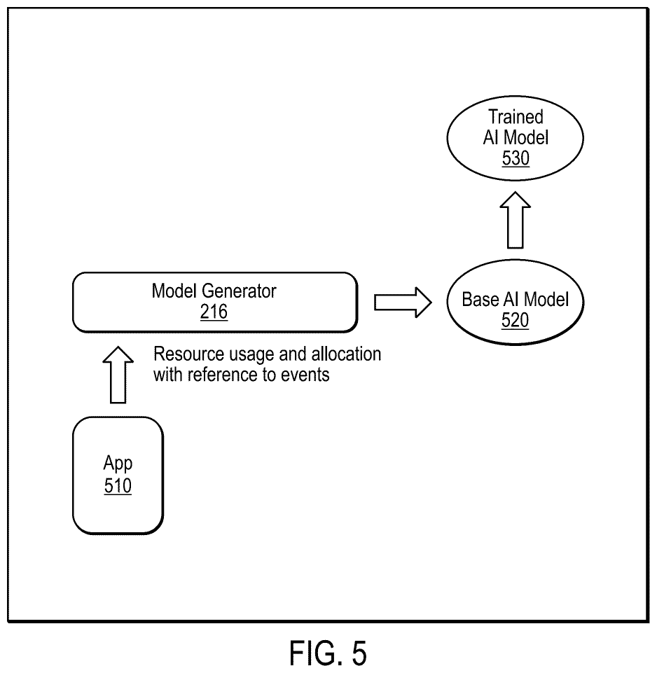

FIG. 5 illustrates a test environment for training a base AI model 520 in accordance with certain embodiments. In the test environment, the application 510 is not under resource constraints. In FIG. 5, a model generator 216 receives application event information and telemetry information about the application resource usage (i.e., resource usage and allocation with reference to events directly or indirectly related to the application 510) based on the application 510 being monitored. The model generator 216 uses the resource usage and allocation with reference to events to train the base AI model 520 for the application. The events-aware autoscaling resource manager 210 may then use the trained AI model 530 to dynamically allocate resources for the application 510. In certain embodiments, the events-aware autoscaling resource manager 210 allocates more resources or fewer resources if utilization is within some threshold of allocation.

In certain embodiments, the application is in a container, and the application event information is application container event information. In certain embodiments, the telemetry information indicates a resource (e.g., memory) and amount of that resource that was used (e.g., 5 Gigabytes).

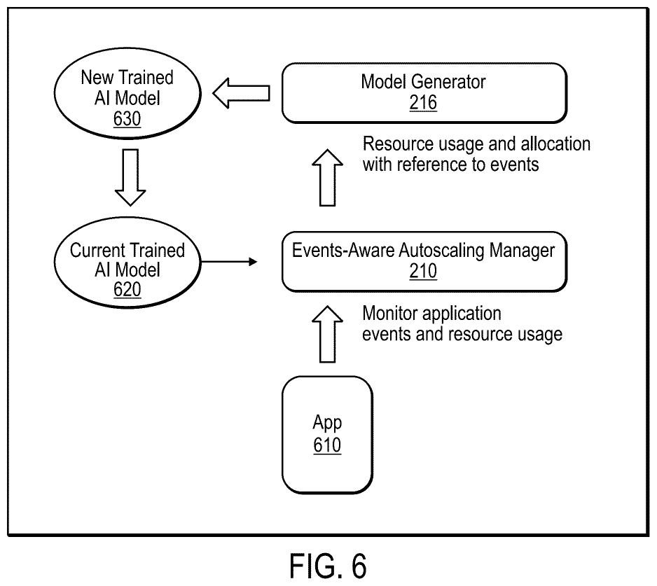

FIG. 6 illustrates a deployment environment for generating a new (fine-tuned) trained AI model 630 in accordance with certain embodiments. In certain embodiments, the base AI model has been trained to generate the initial, current trained AI model 620 in the test environment. In certain embodiments, based on monitoring the performance of the application, the events-aware autoscaling resource manager 210 may fine-tune the current trained AI model 244 when the current trained AI model 244 has provided either too many or too few resources for an application. In the deployment environment, the application 610 is under resource constraints.

In FIG. 6, the events-aware autoscaling resource manager 210 collects application event information and telemetry information about the application resource usage (i.e., resource usage and allocation with reference to events directly or indirectly related to the application 610). The events-aware autoscaling resource manager 210 sends the resource usage and allocation with reference to events for the application 610 to the model generator 216 as inputs. The model generator 216 then uses these inputs with the current trained AI model 620 to fine tune the current trained AI model 620 and generate a new trained AI model 630. The new trained AI model 630 may be said to be a fine-tuned model. In certain embodiments, the model generator 216 generates the new trained AI model 630 periodically. The events-aware autoscaling resource manager 210 may then use the new trained AI model 630 to dynamically allocate resources for the application 610. In certain embodiments, the events-aware autoscaling resource manager 210 allocates more resources or fewer resources if utilization is within some threshold of allocation.

That is, in certain embodiments, model generator 216 of the events-aware autoscaling resource manager 210 trains the base AI model 242 to generate the trained AI model 244, which is used by the resource allocator 218 of the events-aware autoscaling resource manager 210 to perform vertical scaling of amounts of computer resources. The model generator 216 inputs training data to the base AI model 242, where the training data comprises information respectively describing sets of event sequences that have been input to an application and amounts of computing resources that were needed for the application to appropriately perform for an event related to the event sequences, and where the amounts of computing resources constitute ground truth values for the training.

In certain embodiments, the events-aware autoscaling resource manager 210 adjusts (i.e., fine tunes) the trained AI model 244 to produce output of a resource allocation recommendation that matches the ground truth values. In particular, the events-aware autoscaling resource manager 210 may also adjust the trained AI model 244 when it notices that the trained AI model 244 has provided a resource allocation recommendation that recommended an inadequate amount of resources (e.g., either too few resources or too many resources) as described with reference to FIG. 6. The adjustment (re-training or fine tuning) generates a new trained AI model 630 using, in part, the current trained AI model 620. That is, the events-aware autoscaling resource manager 210 is able to understand that the trained AI model 244 should be adjusted based on monitoring the health (e.g., performance) of the application being managed.

The base AI model 242 may operate with a feature space having a number of features equal to a number of various types of events, where the feature space includes binary values indicating whether any of the events arrived in the system during a monitoring period. The feature space may also include a one-hot encoded representation of the last event that happened during the monitoring period. The feature space may also include an event rate of the system. The training of the base AI model 242 may be performed in a testing environment without resource constraints or in a deployment environment with resource constraints.

In certain embodiments, the events-aware autoscaling resource manager 210 considers events and event rates as features to train the base AI model 242. In other embodiments, the events-aware autoscaling resource manager 210 considers events and the rate of requests as features to train the base AI model 242.

For example, for an asset management system, an event may define a new asset class, which is performed by a set of privileged users, while a request may be updating the performance information of an asset in an asset class. Resources (e.g., memory 230, CPU 232, network bandwidth, storage devices 270, etc.) for an application instance of the asset management system may be defined based on how frequently the updates of performance information happen, which is different from the rate at which the events which the base AI model 242 needs to take into account happen.

The events-aware autoscaling resource manager 210 monitors the resource consumption and the events arriving in the system. In certain embodiments, the monitoring of resources is aggregated into a monitoring period. The monitoring period may be specified by a user (e.g., a system administrator). The net results are represented in a time-series of monitored resources along with the events that arrived during the monitoring period.

In certain embodiments, the events-aware autoscaling resource manager 210 monitors the following for each monitoring period: (i) the events that arrive/occur in the monitoring period (ii) the rate of events during the monitoring period, and (iii) the amount of resources that an application consumes during that monitoring period. The resources may be: memory 230, CPU 232, network bandwidth, storage devices 270, etc.

If an application has K events, the events-aware autoscaling resource manager 210 converts the monitored information to a set of features that may be used to train the base AI model 242. In certain embodiments, the features consist of (i) K binary values indicating whether any of the K events arrived in the system during the monitoring period, (ii) one-hot encoded representation of the last event that happened before the start of the monitoring period, which would result in another K binary value (where one-hot for the last event refers to a group of bits among which the legal combinations of values are those with a single high (1) bit and all the others low (0)), (iii) the event rate of the system, and (iv) the resource usage of the application. Items (i), (ii) and (iii) form the set of 2K+1 features that are used to predict the item (iv) the resource usage of the application.

A trained AI model 244 may be used to predict each system resource independently. In certain embodiments, the trained AI model 244 may determine a numeric value for each type of resource.

The base AI model 242 and the trained AI models 244 may use any regressor model (e.g. a Decision Tree based Regression model, a Stochastic Gradient Regression model, rule-based, neural network, etc.). A Decision Tree based model determines different states based on event arrival and fits different linear regression models based on various states automatically. In other embodiments, other models (e.g., a predictive resource consumption model, a rule-based model, etc.) may also be used to determine the amount of resources to be allocated.

To show the impact of using a trained AI model 244 that incorporated the arrival of events into the resource prediction, embodiments show the results over the resource prediction of the simulated environment. In this environment, a single resource is modeled, although more than one resource may be modeled by a regression model without loss of generality. In the simulated environment, the use of the trained AI model 244 provides improvements in application performance due to improved resource allocation.

The simulated environment used three events. One of these events results in an increased resource usage for a fixed period of time, while the other two events result in resource consumption being used at different levels for a same period of time. Based on the above approach, a base event-aware Decision Tree Regression model was trained to take into account the last 2K+1 time intervals. The resource consumption predicted by the trained event-aware Decision Tree Regression model (i.e., an example of a trained AI model 244) was compared to the actual resource consumption and to the resource consumption predicted by a trained event-agnostic Resource Extrapolation model (i.e., an example of an event-agnostic trained AI model). The event-agnostic Resource Extrapolation trained model is used by averaging the resource consumption for the last few time intervals to extrapolate resources to be used in the next time interval.

In the simulated environment, a small buffer was added to the predicted resource usage, which may reduce the occurrence of too little resource allocation. In the simulation, embodiments assume that the system allocates a buffer that is 25% more resources than the average resource consumption of the application. This resulted in two metrics to compare the technique's performance (i) the mean square error and (ii) the probability of starvation of resources in any monitoring period.

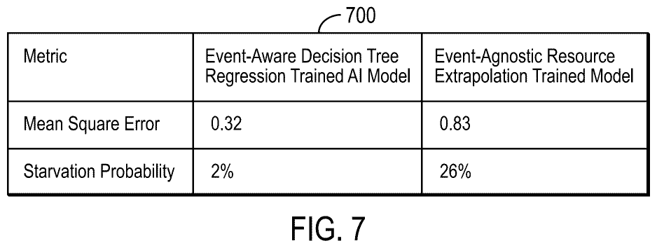

FIG. 7 illustrates a table 700 comparing performance for an event-aware trained AI model 244 and an event-agnostic trained AI model in accordance with certain embodiments. Table 700 uses the metrics of mean square error (in the prediction of resources) and starvation probability for the event-aware Decision Tree Regression trained AI model and the event-agnostic Resource Extrapolation trained model. The starvation probability refers to a fraction of the monitoring period in which a model allocated fewer resources than the system desired.

As can be seen from table 700, the event-aware Decision Tree Regression trained AI model performed better than an event-agnostic Resource Extrapolation trained model. For example, the mean square error and the starvation probability are both smaller for the event-aware Decision Tree Regression trained AI model.

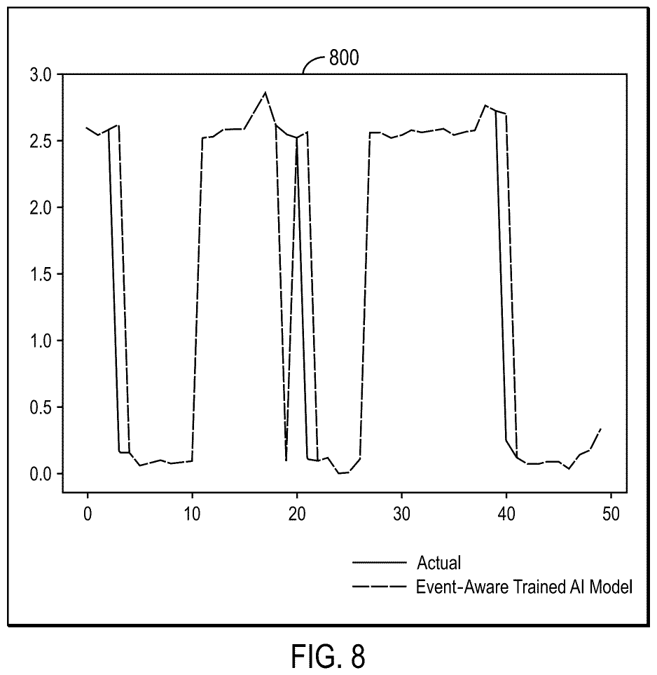

FIG. 8 illustrates a graph 800 of actual resource consumption versus a prediction of resources using an event-aware Decision Tree Regression trained AI model in accordance with certain embodiments. In the graph 800, the x-axis shows a monitoring time-period, while the y-axis shows the amount of resources used/predicted. The graph 800 shows that the event-aware Decision Tree Regression trained AI model almost always allocated sufficient resources to cover the resource needs of the application. The amount of allocated resources usually appropriately subsided with a dip that trailed a dip in the needed resources to provide a resource cushion for the running application without wasting large amounts of unnecessary resources. In FIG. 8, the solid line representing the model-controlled allocated resources over some stretches seems to disappear because it runs essentially colinearly with the dotted line representing the actual resources consumed by the running application.

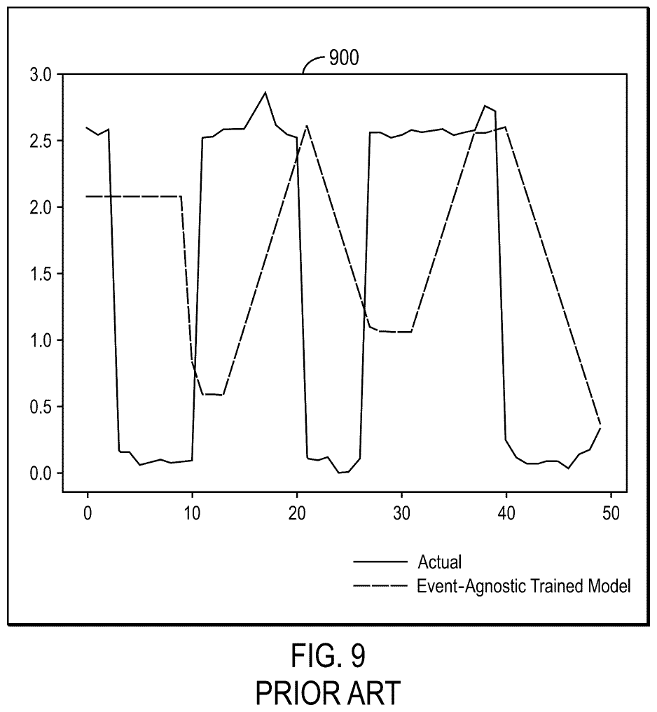

FIG. 9 illustrates a graph 900 of actual resource consumption versus a prediction of resources using an event-agnostic Resource Extrapolation trained model in accordance with certain embodiments. In the graph 900, the x-axis shows a monitoring time-period, while the y-axis shows the amount of resources used/predicted. Due to the event-agnostic model, FIG. 9 could be considered to disclose performance of a prior art model.

With reference to FIGS. 8 and 9, the event-aware trained AI model and event-agnostic trained model are illustrated for a fraction of the simulated environment. As can be seen from FIG. 8, incorporating an awareness of events into the auto-scaling process improves resource allocation. FIG. 9 shows that the event-agnostic trained model performed much worse with multiple instances of far too few or far too many resources allocated over longer durations of a time period. In particular, the event-aware trained AI model is better at avoiding resource starvation and also tracking the resource consumption than the events-agnostic trained model is.

In certain embodiments, the events-aware autoscaling resource manager 210 uses the trained AI model 244 that correlates the type of event to resource consumption. In certain embodiments, the trained AI model 244 also receives as input other characteristics of the arrival process of events. Some examples of such characteristics of the arrival process of events include: the inter-event arrival time, variance of arrival times, rates of arrival of events as measured over some monitoring period, etc.

Thus, in certain embodiments, the events-aware autoscaling resource manager 210 intelligently scales resources allocated to applications with an event monitor 212 to monitor the type of events arriving at an application and to collect application event information about the events, a resource monitor 214 to monitor the resources used by the application and to collect telemetry information about the application resource usage, a model generator 216 to train a base AI model 242 for resource allocation on arrival of information representing different sequences of events, and a resource allocator 218 to allocate different amounts of resources to the application on arrival of the different sequences of events according to the resource allocation recommendation from the trained AI model 244. In certain embodiments, the resource allocator 218 uses a trained AI model 244 across application event information and telemetry information to allocate resources to the application.

Moreover, a model generator 216 correlates the application event information and telemetry information to train a base AI model 242 for allocating resources. In certain embodiments, the model generator 216 is part of a test environment and learns application event characteristics and telemetry information without resource constraints. In certain alternative embodiments, the model generator 216 generates a new AI model 244 periodically (or fine-tunes a previous model) based on updates by the events-aware autoscaling resource manager 210.

In certain embodiments, the model generator 216 uses a test harness to generate tests to measure the performance of the application. In addition, the events-aware autoscaling resource manager 210 ties sequences of events for an application (identified by the event monitor 212) to the resource usage (identified by the resource monitor 214) based on the time a particular sequence of events was received and the resource usage soon after that. In certain embodiments, the model generator 216 classifies different event types into modalities capturing resources uses by the application. In certain embodiments, the model generator 216 uses the classification categories to train the base AI model 242.

In certain embodiments, the events-aware autoscaling resource manager 210 allocates computer resources via vertical scaling. In particular, the events-aware autoscaling resource manager 210 inputs information about an application and messages/information/data respectively describing an event sequence related to an application operating on the application container into a base AI model 242 to generate a trained AI model 244 such that, in response, the trained AI model 244 allocates an amount of computing resources for the application container to appropriately perform for an event related to the event sequence. In certain embodiments that use containers to support applications, the events-aware autoscaling resource manager 210 inputs information about a container used to run an application. In certain other embodiments, the information may include information about the virtual machine used to house the application, and, in yet other embodiments, the information may include information for the physical machines (i.e., computers) that are used for the application.

The messages/information/data received by the manager 210 or by the trained AI model 244 may include information about respective timing of the application container receiving the data that represents the event sequences. The amount of computing resources may constitute an increase (e.g., to prevent thrashing when the application needs more resources) or a decrease (e.g., to avoid waste when a high-resource need is finished) of the computing resources compared to a current amount of computing resources allocated to the application container. The events of the event sequences may be determined by parsing log events associated with the application container.

Telemetry information about the application may also be input into the base AI model 242 to generate a trained AI model 244, such that the trained AI model 244 uses the telemetry information along with the identified event sequences to generate, as output, a resource allocation recommendation of the amount of computing resources to allocate to the application.

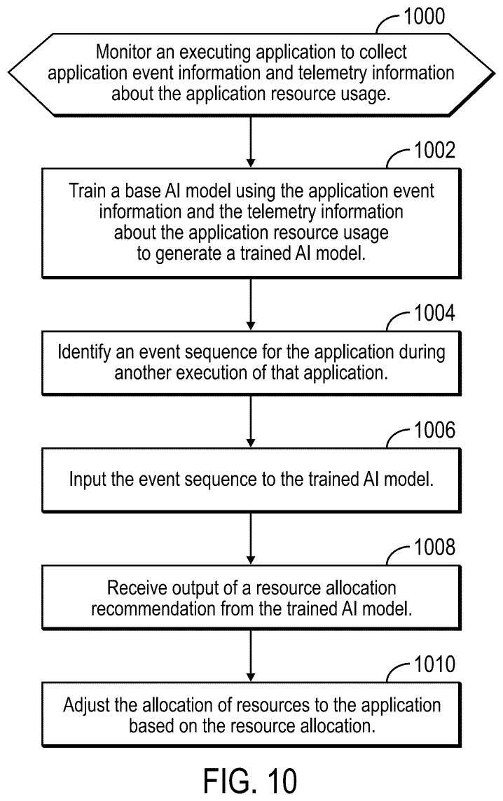

FIG. 10 illustrates, in a flowchart, operations for training and using a trained AI model in accordance with certain embodiments. Control begins at block 1000 with the events-aware autoscaling resource manager 210 monitoring an executing application to collect application event information and telemetry information about the application resource usage. In block 1002, the events-aware autoscaling resource manager 210 trains a base AI model 242 using the application event information and the telemetry information about the application resource usage to generate a trained AI model. In block 1004, the events-aware autoscaling resource manager 210 identifies an event sequence for the application during another execution of that application. In block 1006, the events-aware autoscaling resource manager 210 inputs the event sequence to the trained AI model 244. In block 1008, the events-aware autoscaling resource manager 210 receives output of a resource allocation recommendation from the trained AI model 244. In block 1010, the events-aware autoscaling resource manager 210 adjusts the allocation of resources to the application based on the resource allocation.

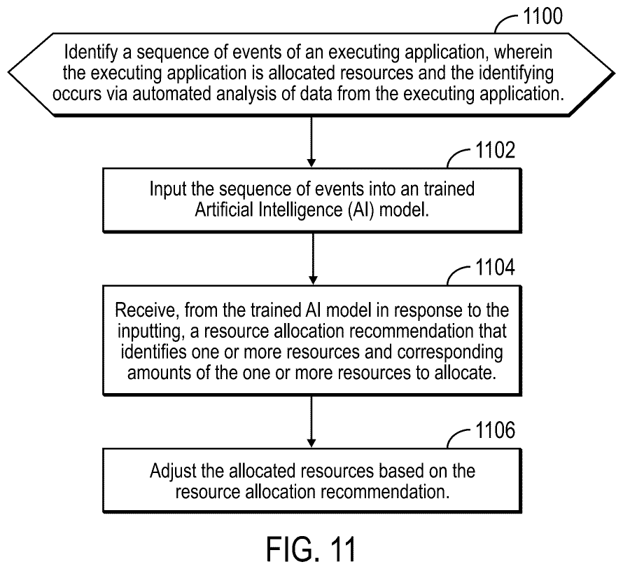

FIG. 11 illustrates, in a flowchart, operations for events-aware autoscaling in accordance with certain embodiments. Control begins at block 1100 with the events-aware autoscaling resource manager 210 identifying a sequence of events of an executing application, where the executing application is allocated resources and the identifying occurs via automated analysis of data from the executing application. In block 1102, the events-aware autoscaling resource manager 210 inputs the sequence of events into a trained Artificial Intelligence (AI) model. In block 1104, the events-aware autoscaling resource manager 210 receives, from the trained AI model in response to the inputting, a resource allocation recommendation that identifies one or more resources and corresponding amounts of the one or more resources to allocate. In block 1106, the events-aware autoscaling resource manager 210 adjusts the allocated resources based on the resource allocation recommendation.

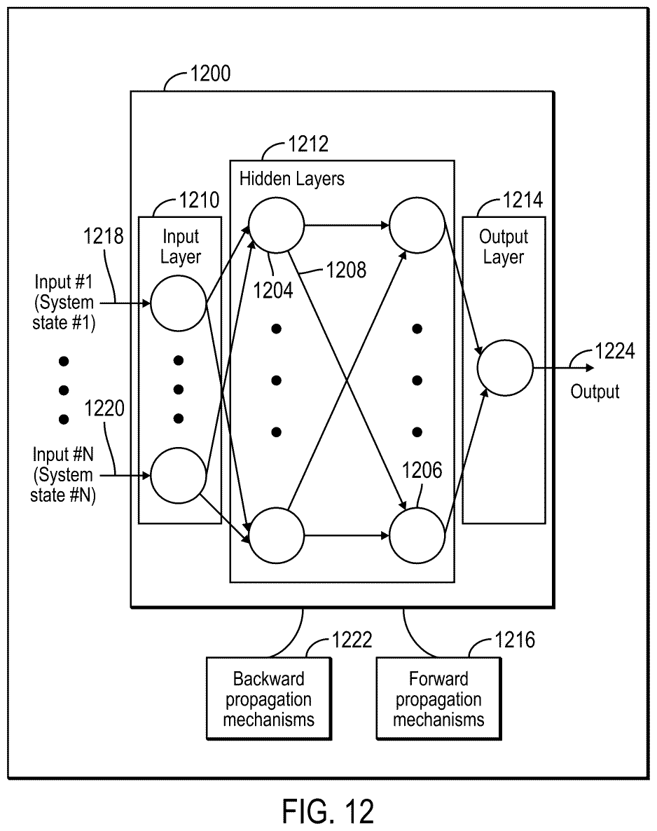

FIG. 12 illustrates, in a block diagram, details of a machine learning model 1200 in accordance with certain embodiments. In certain embodiments, the base AI model 242 and the trained AI model 244 are each implemented using the components of the machine learning model 1200.

The machine learning model 1200 may comprise a neural network with a collection of nodes with links connecting them, where the links are referred to as connections. For example, FIG. 12 shows a node 1204 connected by a connection 1208 to the node 1206. The collection of nodes may be organized into three main parts: an input layer 1210, one or more hidden layers 1212, and an output layer 1214.

The connection between one node and another is represented by a number called a weight, where the weight may be either positive (if one node excites another) or negative (if one node suppresses or inhibits another). Training the machine learning model 1200 entails calibrating the weights in the machine learning model 1200 via mechanisms referred to as forward propagation 1216 and backward propagation 1222. Bias nodes that are not connected to any previous layer may also be maintained in the machine learning model 1200. A bias may be described as an extra input of 1 with a weight attached to it for a node.

In forward propagation 1216, a set of weights are applied to the input data 1218 . . . 1220 to calculate the output 1224. For the first forward propagation, the set of weights may be selected randomly or set by, for example, a system administrator. That is, in the forward propagation 1216, embodiments apply a set of weights to the input data 1218 . . . 1220 and calculate an output 1224.

In backward propagation 1222 a measurement is made for a margin of error of the output 1224, and the weights are adjusted to decrease the error. Backward propagation 1222 compares the output 1224 that the machine learning model 1200 produces with the output that the machine learning model 1200 was meant to produce, and uses the difference between them to modify the weights of the connections between the nodes of the machine learning model 1200, starting from the output layer 1214 through the hidden layers 1212 to the input layer 1210, i.e., going backward in the machine learning model 1200. In time, backward propagation 1222 causes the machine learning model 1200 to learn, reducing the difference between actual and intended output to the point where the two come very close or coincide.

The machine learning model 1200 may be trained using backward propagation to adjust weights at nodes in a hidden layer to produce adjusted output values based on the provided input data 1218 . . . 1220. A margin of error may be determined with respect to the actual output 1224 from the machine learning model 1200 and an expected output to train the machine learning model 1200 to produce the desired output value based on a calculated expected output. In backward propagation, the margin of error of the output may be measured and the weights at nodes in the hidden layers 1212 may be adjusted accordingly to decrease the error.

Backward propagation may comprise a technique for supervised learning of artificial neural networks using gradient descent. Given an artificial neural network and an error function, the technique may calculate the gradient of the error function with respect to the artificial neural network's weights.

Thus, the machine learning model 1200 is configured to repeat both forward and backward propagation until the weights of the machine learning model 1200 are calibrated to accurately predict an output.

The machine learning model 1200 implements a machine learning technique such as decision tree learning, association rule learning, artificial neural network, inductive programming logic, support vector machines, Bayesian models, etc., to determine the output 1224.

In certain machine learning model 1200 implementations, weights in a hidden layer of nodes may be assigned to these inputs to indicate their predictive quality in relation to other of the inputs based on training to reach the output 1224.

With embodiments, the machine learning model 1200 is a neural network, which may be described as a collection of “neurons” with “synapses” connecting them.

With embodiments, there may be multiple hidden layers 1212, with the term “deep” learning implying multiple hidden layers. Hidden layers 1212 may be useful when the neural network has to make sense of something complicated, contextual, or non-obvious, such as image recognition. The term “deep” learning comes from having many hidden layers. These layers are known as “hidden”, since they are not visible as a network output.

In certain embodiments, training a neural network may be described as calibrating all of the “weights” by repeating the forward propagation 1216 and the backward propagation 1222.

In backward propagation 1222, embodiments measure the margin of error of the output and adjust the weights accordingly to decrease the error.

Neural networks repeat both forward and backward propagation until the weights are calibrated to accurately predict the output 1224.

In certain embodiments, the inputs to the machine learning model 1200 are an event sequence and an application identifier, and the outputs of the machine learning model 1200 is a resource allocation recommendation (i.e., an indication of which resources to allocate and how much of those resources to allocate, such as allocate 5 Gigabytes of memory). In certain embodiments, the machine learning model may be refined based on whether the outputted recommendations, once taken, generate positive outcomes based on how the application executes.

In certain embodiments, the inputs to a first trained machine learning model of the event monitor 212 are metrics and/or logs, and the output of the first trained machine learning model is an event or an event sequence. The identified event or the identified event sequence is output from the first trained machine learning model of the event monitor 212 and used as input for a second trained machine learning model for the resource allocator 218. The second trained machine learning model outputs a resource allocation recommendation. In certain embodiments, the first and second machine learning models may be refined based on whether the outputted recommendations, once taken, generate positive outcomes based on how the application executes.

The letter designators, such as i, among others, are used to designate an instance of an element, i.e., a given element, or a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A computer-implemented method, comprising operations for:
identifying a sequence of events of an executing application, wherein the executing application is allocated resources and the identifying occurs via automated analysis of data from the executing application;
inputting the sequence of events into a trained Artificial Intelligence (AI) model;
receiving, from the trained AI model in response to the inputting, a resource allocation recommendation that identifies one or more resources and corresponding amounts of the one or more resources to allocate; and
adjusting the allocated resources based on the resource allocation recommendation.

2. The computer-implemented method of claim 1, wherein the operations further comprise:
training a base AI model using application event information and resource usage information to generate the trained AI model in a testing environment.

3. The computer-implemented method of claim 1, wherein the operations further comprise:
fine-tuning the trained AI model in a deployment environment.

4. The computer-implemented method of claim 1, wherein the executing application is executing within a container.

5. The computer-implemented method of claim 1, wherein the operations further comprise:
parsing a log for the executing application to identify the sequence of events.

6. The computer-implemented method of claim 1, wherein adjusting the allocated resources comprises one of increasing the allocated resources and decreasing the allocated resources.

7. The computer-implemented method of claim 1, wherein the sequence of events is identified within a monitoring period.

8. A computer program product comprising:
one or more computer-readable storage media; and
program instructions stored on the one or more storage media to perform operations comprising:
identifying a sequence of events of an executing application, wherein the executing application is allocated resources and the identifying occurs via automated analysis of data from the executing application;
inputting the sequence of events into a trained Artificial Intelligence (AI) model;
receiving, from the trained AI model in response to the inputting, a resource allocation recommendation that identifies one or more resources and corresponding amounts of the one or more resources to allocate; and
adjusting the allocated resources based on the resource allocation recommendation.

9. The computer program product of claim 8, wherein the operations further comprise:
training a base AI model using application event information and resource usage information to generate the trained AI model in a testing environment.

10. The computer program product of claim 8, wherein the operations further comprise:
fine-tuning the trained AI model in a deployment environment.

11. The computer program product of claim 8, wherein the executing application is executing within a container.

12. The computer program product of claim 8, wherein the operations further comprise:
parsing a log for the executing application to identify the sequence of events.

13. The computer program product of claim 8, wherein adjusting the allocated resources comprises one of increasing the allocated resources and decreasing the allocated resources.

14. The computer program product of claim 8, wherein the sequence of events is identified within a monitoring period.

15. A computer system comprising:
a processor set;
one or more computer-readable storage media; and
program instructions stored on the one or more storage media to cause the processor set to perform operations comprising:
identifying a sequence of events of an executing application, wherein the executing application is allocated resources and the identifying occurs via automated analysis of data from the executing application;
inputting the sequence of events into a trained Artificial Intelligence (AI) model;
receiving, from the trained AI model in response to the inputting, a resource allocation recommendation that identifies one or more resources and corresponding amounts of the one or more resources to allocate; and
adjusting the allocated resources based on the resource allocation recommendation.

16. The computer system of claim 15, wherein the operations further comprise:
training a base AI model using application event information and resource usage information to generate the trained AI model in a testing environment.

17. The computer system of claim 15, wherein the operations further comprise:
fine-tuning the trained AI model in a deployment environment.

18. The computer system of claim 15, wherein the executing application is executing within a container.

19. The computer system of claim 15, wherein the operations further comprise:
parsing a log for the executing application to identify the sequence of events.

20. The computer system of claim 15, wherein adjusting the allocated resources comprises one of increasing the allocated resources and decreasing the allocated resources.
